(19) United States
(12) Patent Application Publication
(10) Pub. No.: US 2021/0192613 A1
(43) Pub. Date: Jun. 24, 2021

(54) OBJECT LINKAGE CONFIGURATION FOR A LOAN ORIGINATION SYSTEM

(71) Applicant: Patch of Land, Inc, Sherman Oaks, CA (US)

(72) Inventors: Robert Greenberg, Dallas, TX (US); Sanjay Prajapati, Santa Clarita, CA (US); Chelsea Strong, Encino, CA (US)

(73) Assignee: Patch of Land, Inc, Sherman Oaks, CA (US)

(21) Appl. No.: 16/721,617

(22) Filed: Dec. 19, 2019

(51) Int. Cl. G06Q 40/02; G06F 16/901

(52) U.S. Cl. CPC G06Q 40/025; G06Q 50/167; G06F 16/9027

(57) ABSTRACT

A computer-implemented loan origination system has a processor that generates a plurality of first level objects, generates a plurality of second level objects, generates an object linkage between the plurality of first level objects, and automatically propagates an update of one of a second subset of the plurality of second level objects to a first subset of the plurality of second level objects. The plurality of first level objects includes a sales object and an operations object. Furthermore, the first subset of the plurality of second level objects corresponds to, and is accessible by, the sales object; whereas the second subset of the plurality of second level objects corresponds to, and us accessible by, the operations object. The object linkage provides each of the plurality of first level objects shared access to each of the plurality of second level objects.

### BACKGROUND

### 1. Field

This disclosure generally relates to computing systems. More particularly, the disclosure relates to the field of financial computing systems.

### 2. General Background

In order to process a loan, such as a mortgage, many lenders have a detailed process called loan origination, which outlines how the loan is to be handled from the start of the loan application process all the way to the funding of the loan at closing. Although advances in technology have helped spur automation in many industries, the lending industry has not kept up with the pace of such other industries.

For example, human representatives of various departments on a loan origination team are typically responsible for transitioning a particular loan file from one department to another. Yet, if that transition occurs too early in the loan origination process, the loan file may have to be sent back to the department that originally sent the loan file. Accordingly, a conventional loan origination configuration typically involves multiple transitions of a loan file back and forth between various departments of the loan origination team; such a conventional approach is typically fraught with either redundancies, to prevent the possibility of error, or inadequate data flow between departments, leaving the possibility for error. For instance, with respect to redundancies in a conventional loan origination configuration, one department may have to perform independent data validation, which may also have already been performed by another department. These redundancies may lead to computing inefficiencies because multiple validation attempts to validate data can result in unnecessary use of computing resources that may be necessary for other tasks in the loan origination configuration; such inefficiencies become particularly apparent on a mass scale whereby the loan configuration is handling a significant quantity of loans, many of which may be the subject of such multiple data validation attempts. Alternatively, or in addition, the loan origination configuration may allow data to flow from one department to another without the loan origination team participants attempting to validate data that has moved in a backwards manner. Without validation, such approach is prone to error.

Ultimately, current loan origination configurations are too reliant on loan origination team participants to monitor and transition loan data back and forth throughout the loan origination process. These user-dependent systems create redundancies leading to computing inefficiencies, or data gaps leading to computing errors.

### SUMMARY

A computer-implemented loan origination system (“LOS”) has a processor that generates a plurality of first level objects, generates a plurality of second level objects, generates an object linkage between the plurality of first level objects, and automatically propagates an update of one of a second subset of the plurality of second level objects to a first subset of the plurality of second level objects. The plurality of first level objects includes a sales object and an operations object. Furthermore, the first subset of the plurality of second level objects corresponds to, and is accessible by, the sales object; whereas the second subset of the plurality of second level objects corresponds to, and is accessible by, the operations object. The object linkage provides each of the plurality of first level objects shared access to each of the plurality of second level objects. The computer-implemented LOS also has a memory device that stores a multi-object data structure to store the object linkage.

As an alternative, a computer program product may have a computer readable storage device with a computer readable program stored thereon that implements the functionality of the aforementioned computer-implemented LOS. As yet another alternative, a process that utilizes a processor may implement the functionality of the aforementioned computer-implemented LOS.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an LOS configuration.

FIG. 2 illustrates a system configuration for the computer-implemented LOS platform illustrated in FIG. 1.

FIG. 3 illustrates an example of a multi-object data structure that is a tree-based hierarchical configuration.

FIG. 4 illustrates an example of a multi-object data structure that is a two-dimensional array, such as a table.

FIG. 5A illustrates the loan origination workflow operating in sequence from a sales stage to an operations stage.

FIG. 5B illustrates the loan origination workflow operating in a non-sequential manner.

FIG. 6 illustrates various devices and corresponding human operators performing the non-sequential workflow illustrated in FIG. 5B.

FIG. 7 illustrates a process that may be utilized by the computer-implemented LOS platform to perform object linkage and data propagation during a loan origination workflow.

### DETAILED DESCRIPTION

An object linkage configuration is provided for an LOS. In particular, the object linkage configuration has a multi-object data structure that manages the loan origination process via a plurality of loan origination component objects. (An “object” referred to herein may be a data construct (e.g., database record, data type, data class, data container, etc.) that is used to invoke a particular instance of a set of data with one or more predefined properties (i.e., associated functionality, user permissions, etc.).) For example, the loan origination process may be bifurcated into two first level objects, such as a sales object and an operations object. In one embodiment, generation of an additional first level object is contingent upon one more criteria being met for one or more second level objects of an initial first level object. For example, the sales object may have various sub-objects. Upon population of certain fields corresponding to the sub-objects of the sales object, the LOS will generate the operations object. Accordingly, the multi-object data structure prevents data from flowing to the operations object until certain criteria are even met for the sales object, thereby preempting the possibility of loan origination team participants corresponding to the loan object from attempting to manipulate data too early on in the loan origination process. This instance is just one example of how the object linkage configuration eliminates, or minimizes, data redundancies in the LOS. After generation of the loan object, the loan origination workflow may have to revisit the sales object. By linking the sales object and the loan object, data adjustments to a sub-object for an object in a later stage of the loan origination pipeline may be automatically propagated backward through the loan origination pipeline to an earlier-generated object (e.g., data from a sub-object of the operations object may be propagated backward to a sub-object for the sales object). Accordingly, the object linkage configuration links multiple objects in the LOS to reduce data redundancies and avoid, or minimize, computing errors.

Accordingly, the multi-object data structure provides for specific computing improvements over a configuration without multiple objects. Rather than allowing for unnecessary data flow (e.g., data from a loan origination team member that should occur later in the loan origination process) and/or duplicative data flow (e.g., multiple loan origination team members processing/updating data for the same request), the multi-object data structure may impose lock-step processing of a loan origination workflow via generation of discrete objects at various sequential stages of the loan origination workflow, and object linkage between the objects corresponding to the stages of the workflow. The object linkage allows for automatic data propagation, both forward and backward, through the loan origination workflow, thereby improving the usability of the loan origination workflow via a computing device and maintaining the discrete characteristics of the multi-object data structure that prevent inefficient data flow.

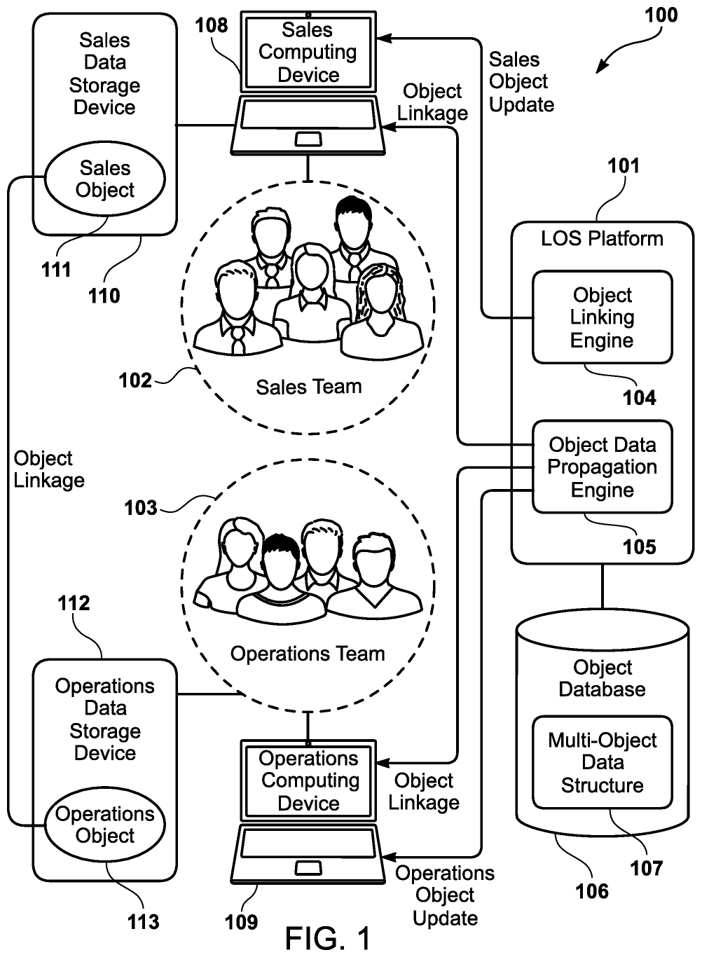

FIG. 1 illustrates an LOS configuration 100. Through a computer-implemented LOS platform 101, the LOS configuration 100 may communicate with various teams/divisions in a loan origination department. For example, the computer-implemented LOS platform 101 may communicate with a sales computing device 108, which is operated by one or more members of a sales team 102. (Only one sales computing device 108 is depicted for ease of illustration. Multiple sales computing devices 108, each corresponding to one of the members of the sales team 102, may be utilized instead.) Furthermore, the sales computing device 108 may have access to a sales object 111, which is stored on a sales data storage device 110 that is in operable communication with the sales computing device 108. (The phrase “operable communication” is intended to encompass communication via an integrated device or an external device.) For instance, members of the sales team 102 may have specific user permissions that allow access to the sales object 111. Accordingly, the members of the sales team 102 may have access confined to a discrete set of data corresponding to sales-related stages of the loan origination workflow.

Also, the computer-implemented LOS platform 101 may communicate with an operations computing device 109, which is operated by one or more members of an operations team 103. (Only one operations computing device 109 is depicted for ease of illustration. Multiple operations computing devices 109, each corresponding to one of the members of the operations team 103, may be utilized instead.) Furthermore, the operations computing device 109 may have access to an operations object 113, which is stored on an operations data storage device 112 that is in operable communication with the operations computing device 109. For instance, members of the operations team 103 may have specific user permissions that allow access to the operations object 113. Accordingly, the members of the operations team 103 may have access confined to a discrete set of data corresponding to operations-related stages of the loan origination workflow.

To avoid confinement of a user's access to a discrete object being too overly restrictive, the computer-implemented LOS platform 101 generates an object linkage, via an object linking engine 104, to link the sales object 111 to the operations object 113. For example, after the sales stage of the loan origination workflow is completed, some, or possibly all, of the data generated during the sales stage may be necessary for use by the operations stage of the loan origination workflow. Instead of the members of the operations team 103 having to search or request such data, the computer-implemented LOS platform 101 automatically propagates, via an object data propagation engine 105, data from the sales object 111 to the operations object 113 based on the operations object 113 being linked to the sales object 111. Upon an object generation event of the operations object 113, the computer-implemented LOS platform 101 performs an automatic migration of data necessitated by the operations object 113. For example, the object data propagation engine 105 may determine that the operations object 113 has a plurality of data fields corresponding to data already stored in the sales object 111, and may perform an automatic migration of such data upon generation of the operations object 113; alternatively, an automatic update to the operations object 113 may be performed based on a modification to the sales object 111. In other words, in one embodiment, the object data propagation engine 105 performs a selective data migration based on empty, or possibly filled, fields of the operations object 113, without migrating all of the data from the sales object 111. As a result, the object data propagation engine 105 minimizes data flow, thereby improving computing efficiency. In one embodiment, the object linkage is between objects, such as the sales object 111 and the operations object 113. In another embodiment, the object linkage may be between specific sub-objects of the objects, thereby allowing for specific, automatic updates for particular fields between objects.

In yet another embodiment, the object linkage is configured to share access only to data for which the linked objects have similar user access permissions. For example, the object linkage may allow access to a loan property address for both the operations object 113 and the sales object 111, but may restrict access to an underwriting checklist to just the operations object 113. Accordingly, the object linkage maintains restricted access to discrete loan origination objects to avoid, or minimize, extraneous data flow, while permitting shared access for overlapping data points to automatically propagate data forward, and potentially backward, through a loan origination pipeline.

The computer-implemented LOS computer-implemented platform 101 may also have an object database 106, which stores a multi-object data structure 107. In essence, the multi-object data structure 107 maintains the object linkages between various objects, various sub-objects, or various objects and various sub-objects. As a result, the object data propagation engine 105 may utilize the multi-object data structure 107 to efficiently determine data flow migrations and updates between objects. Furthermore, the multi-object data structure 107 may store one or more rules corresponding to a particular object linkage. As an example, a rule may be a user permission or a user restriction for a particular data point that is the encompassed by the object linkage. The multi-object data structure 107 may be selected from a variety of data structures (e.g., tree-based hierarchical configuration, multi-dimensional array, etc.).

The sales object 111 and operations object 113 are illustrated herein only as examples of possible objects utilized by the LOS configuration 100. Additional, or different, objects may be utilized instead by the LOS configuration 100.

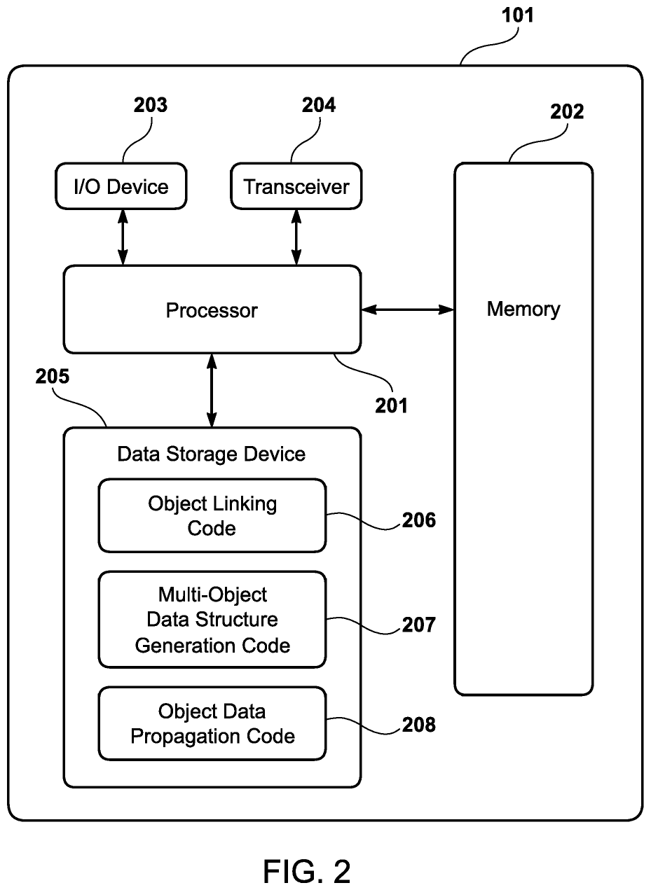

FIG. 2 illustrates a system configuration for the computer-implemented LOS platform 101 illustrated in FIG. 1. In particular, a processor 201, which may be specialized for linking objects, generating data structures, and/or propagating data may be used to perform the operations illustrated in FIG. 1 for object linkage and object data propagation. For example, the processor 201 may be capable of linking objects and generating the multi-object data structure 107, illustrated in FIG. 1. Furthermore, a memory device 202 may store the multi-object data structure 107, or portions thereof, for processing by the processor 201. In essence, the multi-object data structure 107 allows the processor 201 to optimally determine data flow to multiple objects within a loan origination workflow pipeline, whether forward or backward within that pipeline. The memory device 202 may also store computer readable instructions performed by the processor 201. As an example of such computer readable instructions, a data storage device 205 within the system configuration may store object linking code 206, multi-object data structure generation code 207, and object data propagation code 208.

The processor 201 may execute the object linking code 206 to generate an object linkage between a plurality of different loan origination objects. Additionally, the processor 201 may execute the multi-object data structure generation code 207 to generate the multi-object data structure 107 illustrated in FIG. 1. Finally, the processor 201 may execute the object data generation code 208 to propagate data between linked objects.

Moreover, the system configuration may have one or more input/output (“I/O”) devices 203 that may receive inputs and provide outputs. Various devices (e.g., keyboard, microphone, mouse, pointing device, hand controller, etc.) may be used for the I/O devices 203. The system configuration may also have a transceiver 204 to send and receive data. Alternatively, a separate transmitter and receiver may be used instead.

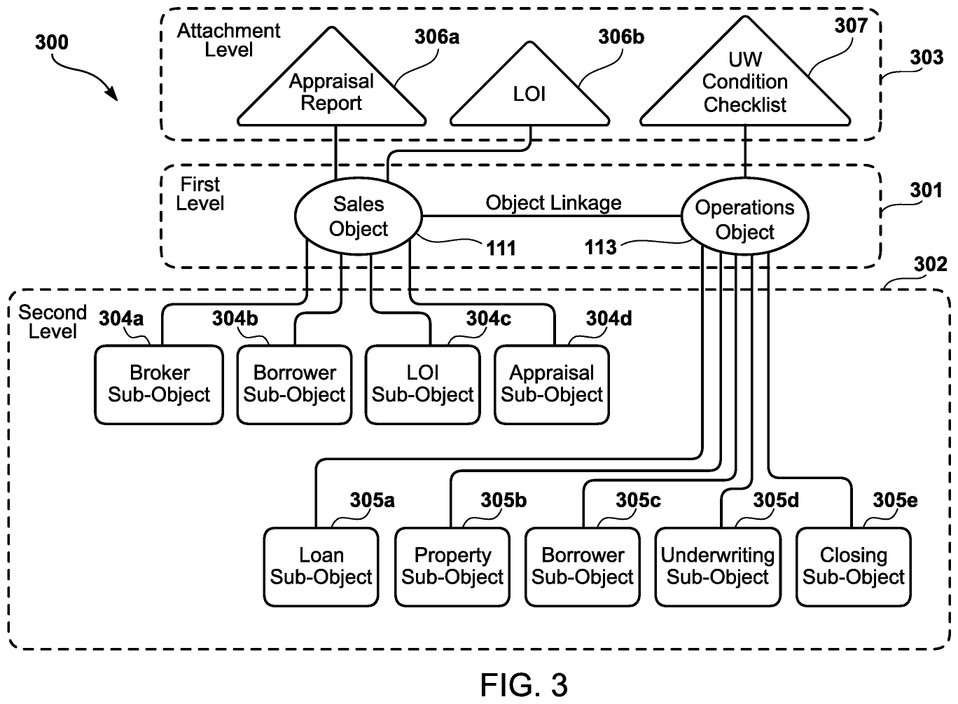

FIG. 3 illustrates an example of a multi-object data structure 107 that is a tree-based hierarchical configuration 300. In particular, the tree-based hierarchical configuration 300 has a plurality of levels. For instance, a first level 301 may have a plurality of first level objects, such as the sales object 111 and the operations object 113. At the first level 301, the multi-object data structure 107 may indicate one or more object linkage indicators (e.g., connectors) indicating which objects are linked to each other. For example, the tree-based hierarchical configuration 300 may indicate a first level object connector that links the sales object 111 and the operations object 113.

Furthermore, the tree-based hierarchical configuration 300 may have a second level 302, which includes a plurality of second level objects, each of which corresponds to one particular object in the first level 301. For example, a first subset of the second level 302 may include a plurality of sub-objects (i.e., children objects) of the sales object 111. In particular, the second level 302 may have a broker sub-object 304a, a borrower sub-object 304b, a letter of intent (“LOI”) sub-object 304c, and an appraisal sub-object 304d. The foregoing sub-objects 304a-d are illustrative of the types of data objects that members of the sales team 102 may be processing at the sales stage of the loan origination process. (Additional or different sub-objects may be used instead.) Accordingly, a member of the sales team 102 may have user permissions to access, via a sales computing device 108, one or more of the sub-objects 304a-d via the sales object 111.

Additionally, a second subset of the second level 302 may include a plurality of sub-objects (i.e., children objects) of the operations object 113. In particular, the second level 302 may have a loan sub-object 305a, a property sub-object 305b, a borrower sub-object 305c, an underwriting sub-object 305d, and a closing sub-object 305e. The foregoing sub-objects 305a-e are illustrative of the types of data objects that members of the operations team 103 may be processing at the operations stage of the loan origination process. (Additional or different sub-objects may be used instead.)

By having the linkage between two first level objects, such as the sales object 111 and the operations object 113, the multi-object data structure 107 provides for shared access to the corresponding second level objects of a particular first level object. For example, because the operations object 113 is linked to the sales object 111, the operations object 113 is able to access data from the subset of second level objects corresponding to the sales object 111 (e.g., the second level objects 304a-d). The foregoing data access may be access-based, without any modification to the operations object 113, or may be update-based, whereby one or more of the second level objects 305a-e corresponding to the operations object 113 are modified based on access to the second level objects corresponding to the sales object 111. Furthermore, the sales object 111 may be able to obtain data access to the subset of second level objects corresponding to the operations object 113 (e.g., the second level objects 305a-g) in a similar manner.

Optionally, the tree-based hierarchical configuration 300 may have an attachment level 303, which includes attachments (e.g., document files, image files, video files, audio files, etc.). A first subset of attachments (e.g., appraisal report 306a and LOI 306b) corresponds to, and is accessible by, the sales object 111, whereas a second set of attachments (e.g., underwriting checklist 307) corresponds to, and is accessible by, the operations object 113. (Other types of attachments (e.g., credit report) may be used other than those described herein.) In one embodiment, because of the linkage between the sales object 111 and the operations object 113, each object has access to the attachments corresponding to the other object. In another embodiment, the LOS computer-implemented platform 101, illustrated in FIG. 1, performs an automatic migration, based on the linkage, of attachments from one object to the other object. For example, given that the operations stage is subsequent to the sales stage, the LOS computer-implemented platform 101 may essentially move, or at least copy, the attachments, corresponding to the sales object 111, from the sales object 111 to the operations object 113. By performing such a migration, the operations object 113 may have direct access to the attachments from previous stages of the loan origination workflow, without having to request such attachments from the sales object 111. Given the time delays associated with downloading attachment files, such migration allows for faster access via a direct access request within the operations object 113 itself after migration, thereby improving computing efficiency. Such migration is not limited to the attachment level 303, and can also be applicable to the second level 302.

The term “correspond,” when described with respect to FIG. 3, is intended to encompass a hierarchical relationship that spans different levels of the hierarchical configuration 300. For example, a node in the first level 301 may correspond to a node in the second level 302, thereby indicating a tree-based child/parent relationship. Conversely, the term “linkage,” when described with respect to FIG. 3, is intended to encompass a relationship between objects on the same level of the hierarchical configuration 300, or on a different level if corresponding to different objects. In other words, the linkage between the first level objects may be denoted by a linkage grouping.

Although the various levels 301-303 are depicted via a hierarchical configuration, the levels 301-303 may alternatively be delineated via other data structures (e.g., an array).

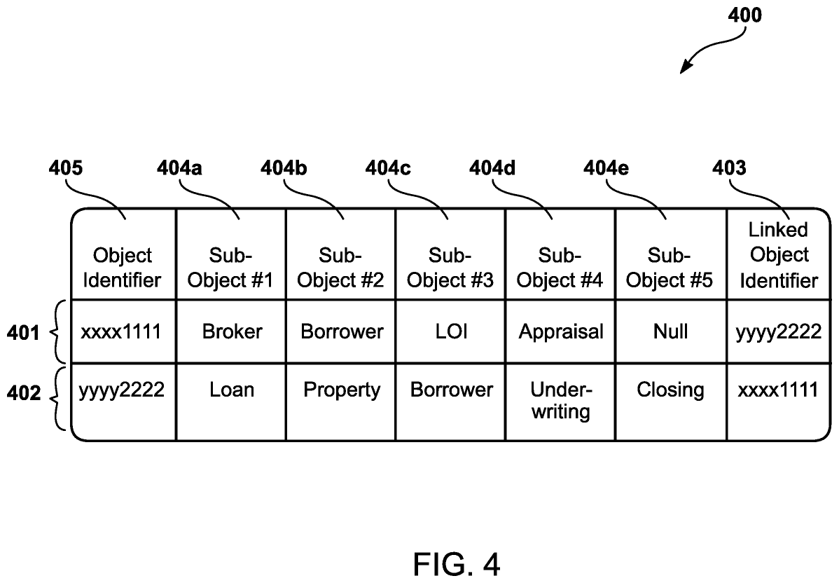

As another example, FIG. 4 illustrates an example of a multi-object data structure 107 that is a two-dimensional array, such as a table 400. For instance, the table 400 may assign each of the first level objects to a distinct row. Furthermore, each column may represent a linked object identifier or a sub-object. For example, a first row 401 may correspond to the sales object 111, and a second row 402 may correspond to the operations object 113. Furthermore, a linked object identifier field 403 may be a column that indicates the object identifier for a particular object that is linked to an object identified by an object identifier field 405. For example, the linked object identifier field 403, corresponding to the first row 401 associated with the sales object 111, may identify an identifier of the operations object 113 for linkage between the sales object 111 and the operations object 113. Similarly, the linked object identifier field 403, corresponding to the second row 402 associated with the sales object 113, may identify an identifier of the sales object 111 for linkage between the operations object 113 and the sales object 111. In this example, the linkage grouping may be the column corresponding to the linked object identifier field 403. (Alternatively, a row, diagonal, or some other grouping may be utilized as the linkage grouping.) Optionally, the multi-object data structure may have additional fields, such as 404a-e, identifying sub-objects corresponding to a particular object.

Each object may potentially have an overlapping sub-object, such as the borrower sub-object 304b corresponding to the sales object 111 and the borrower sub-object 305c corresponding to the operations object 113. In one embodiment, these sub-objects are the same object, being migrated from one object to the other and/or updated in a concurrent manner. In another embodiment, overlapping sub-objects may have similar data, but different features and/or fields.

The tree-based hierarchical configuration 300, illustrated in FIG. 3, and the table 400, illustrated in FIG. 4, are just examples of a multi-object data structure 107. Alternatively, other types of data structures may be used for the multi-object data structure 107.

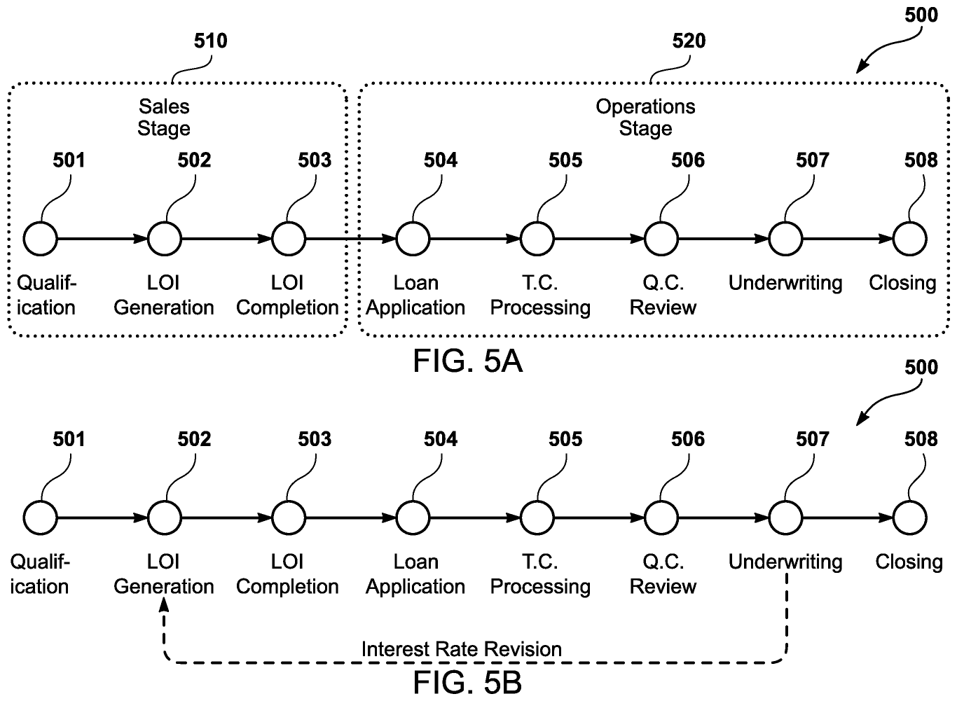

FIGS. 5A and 5B illustrate an example of a loan origination workflow 500 that has stages corresponding to objects, which may be linked within the multi-object data structure 107. For example, FIG. 5A illustrates the loan origination workflow 500 operating in sequence from a sales stage 510 to an operations stage 520. The members of the sales team 102, illustrated in FIG. 1, may proceed through the workflow of the operations stage 520, such as a qualification event 501, LOI generation event 502, and LOI completion event 503. (The foregoing events may represent only some, or different, events in a sales stage 510.). Furthermore, the loan origination workflow 500 may transition from the sales stage 510 to the operations stage 520, such as a loan application event 504, a transaction coordinator processing event 505, a quality control review event 506, and an underwriting event 507, and a closing event 508.

Yet, the proceeding through the loan origination workflow 500 may not always occur in a linear manner. For example, FIG. 5B illustrates the loan origination workflow 500 operating in a non-sequential manner. Up until the underwriting event 507, the loan origination workflow 500 may have worked in sequence, but an underwriting member of the operations team 103 may have determined that an item was missing from the underwriting checklist, thereby triggering an interest rate increase. As a result, the LOI generated at the LOI generation event 502 during the sales stage is no longer valid. The computer-implemented LOS platform 101 may then invoke a request for a new LOI to be generated with a new interest rate, at the LOI generation event 502 of the loan origination workflow 500. The processing of the loan origination workflow 500 has retraced (i.e., moved backwards) to an event in the sales stage 510. Yet, the update to the interest rate in the LOI sub-object 304c, corresponding to the LOI generation event 502, is accessible by the operations object 113. Furthermore, the new LOI may be accessible by, or migrated to, the operations object 113. Accordingly, a retracement in the loan origination workflow 500 does not prevent the LOS computer-implemented platform 101 from efficiently managing and completing the loan origination workflow 500.

The various events illustrated in FIGS. 5A and 5B are provided only for illustration purposes. Additional and/or different events may be utilized for the loan origination workflow 500. Furthermore, additional and/or different stages may be utilized for the loan origination workflow 500.

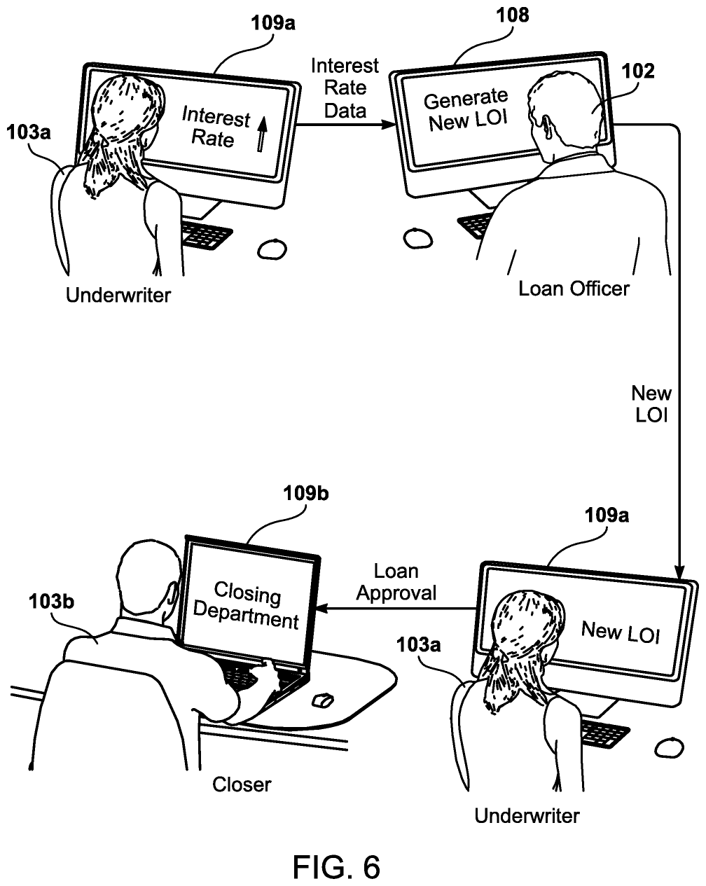

FIG. 6 illustrates various devices and corresponding human operators performing the non-sequential workflow illustrated in FIG. 5B. For example, an underwriter 103a may utilize an operations computing device 109a to invoke an interest increase, which results in the new interest rate data being provided to a sales computing device 108 operated by a loan officer 102. Furthermore, the sales computing device 108 generates the new LOI, which is automatically accessible by the underwriter 103a via the operations computing device 109a. Finally, the loan origination workflow 500 may continue toward completing the closing and generating the closing documents via an operations computing device 109b operated by a closer 103b.

The LOS computer-implemented platform 101 may act as an intermediary between the various computing devices at different stages within the origination workflow 500. For example, rather than having to directly access interest rate data from the loan officer 102, the underwriter 103a may change the interest rate, which automatically results in the LOS-computer-implemented platform 101 updating the interest rate, potentially other data that used the previous interest for particular calculations, and documents that relied on the interest rate. For instance, the LOS-computer-implemented platform 101 may generate a new LOI, at the LOI generation event 502 corresponding to the LOI object 304c, based on the interest rate change. Additional events at the sales stage 510 (e.g., signature of the LOI) may then have to be performed prior to reversion back to the underwriter 103a for review at the operations computing device 109a. For example, the loan officer 102 may have to participate again by signing the revised LOI. Upon reversion back to the underwriter 103 at the operations stage 520, the underwriter 103a may continue the loan origination workflow to request that the closer 103b prepares the closing documents at an operations computing device 109b.

Although the transmission of data is illustrated in FIG. 6 as being transmitted from device-to-device, the data may be transmitted indirectly through the LOS computer-implemented platform 101. For example, the interest rate data may be transmitted form the operations computing device 109a to the LOS computer-implemented platform 101, which transmits the interest rate data to the sales computing device 102. Alternatively, the data may be transmitted from device-to-device, such as through a peer-to-peer network, local area network, messaging application, or wireless communication.

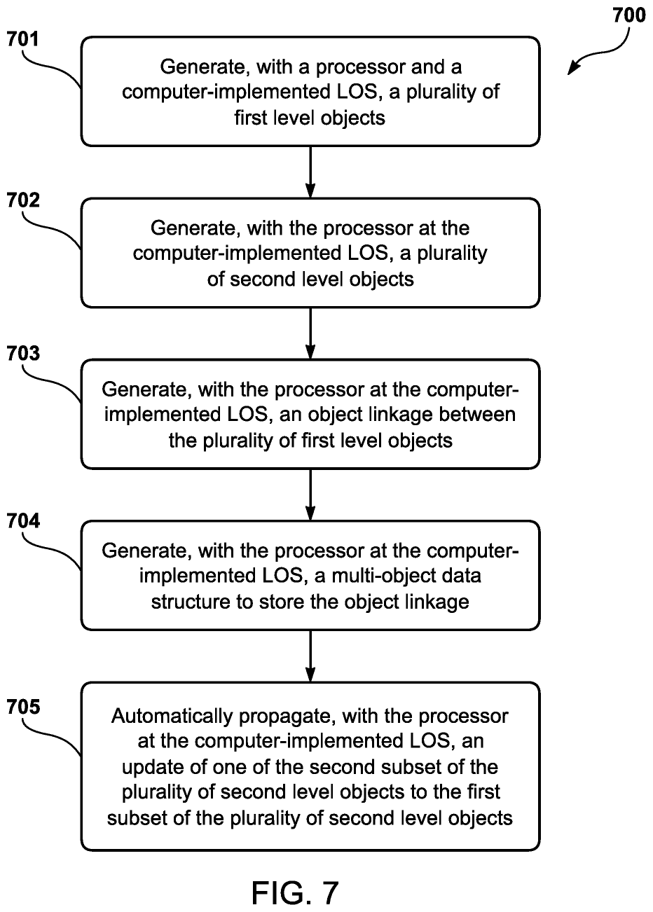

Furthermore, FIG. 7 illustrates a process 700 that may be utilized by the computer-implemented LOS platform 101 to perform object linkage and data propagation during a loan origination workflow. At a process block 701, the process 700 generates, with the processor 201, illustrated in FIG. 2, at the computer-implemented LOS platform 101, a plurality of first level objects. The plurality of first level objects has a sales object 111 and an operations object 113. Furthermore, at a process block 702, the process 700 generates, with the processor 201 at the computer-implemented LOS 101, a plurality of second level objects. A first subset of the plurality of second level objects corresponds to, and is accessible by, the sales object 111. A second subset of the plurality of second level objects corresponds to, and is accessible by, the operations object 113. Additionally, at a process block 703, the process 700 generates, with the processor 201 at the computer-implemented LOS platform 101, an object linkage between the plurality of first level objects. The object linkage provides each of the plurality of first level objects shared access to each of the plurality of second level objects.

Moreover, at a process block 704, the process 700 generates, with the processor 201 at the computer-implemented LOS platform 101, the multi-object data structure 107 to store the object linkage. The multi-object data structure 107 may store a plurality of first level object identifiers in a linkage grouping (e.g., connector indicium that connects objects in a group, tabular grouping in a column, tabular grouping in a row, tabular grouping in a diagonal, etc.) to indicate the object linkage. Finally, at a process block 705, the process 700 automatically propagates, with the processor 201 at the computer-implemented LOS, an update of one of the second subset of the plurality of second level objects to the first subset of the plurality of second level objects.

Various examples have been provided with respect to the mortgage lending industry. Alternatively, the LOS computer-implemented platform 101 may be utilized for other types of loans.

Furthermore, various illustrations have depicted computing devices such as desktop computers. However, the configurations provided for herein may be implemented via mobile computing devices (e.g., smartphones, tablet devices, smartwatches, etc.).

A computer is intended herein to include any device that has a specialized processor as described above. For example, a computer may be a personal computer (“PC”), laptop computer, set top box, cell phone, smartphone, tablet device, smart wearable device, portable media player, video player, etc.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A computer program product comprising a non-transitory computer readable medium having a computer readable program stored thereon, wherein the computer readable program when executed on a computer causes the computer to:
generate, with a processor at a computer-implemented loan origination system, a plurality of first level objects, the plurality of first level objects comprising a sales object and an operations object;
generate, with the processor at the computer-implemented loan origination system, a plurality of second level objects, a first subset of the plurality of second level objects corresponding to, and accessible by, the sales object, a second subset of the plurality of second level objects corresponding to, and accessible by, the operations object;
generate, with the processor at the computer-implemented loan origination system, an object linkage between the plurality of first level objects, the object linkage providing each of the plurality of first level objects shared access to each of the plurality of second level objects;
generate, with the processor at the computer-implemented loan origination system, a multi-object data structure to store the object linkage; and
automatically propagate, with the processor at the computer-implemented loan origination system, an update of one of the second subset of the plurality of second level objects to the first subset of the plurality of second level objects.

2. The computer program product of claim 1, wherein the computer is further caused to automatically generate, with the processor, the second first level object upon one or more criteria corresponding to the first subset of the plurality of second level objects being met.

3. The computer program product of claim 2, wherein the computer is further caused to automatically determine, upon generation of the second first level object, data from the first subset of the plurality of second level objects that are applicable to the second subset of the plurality of second level objects, the computer further being caused to automatically migrate the data from the first subset of the plurality of second level objects to the second subset of the plurality of second level objects.

4. The computer program product of claim 1, wherein the computer is further caused to automatically generate, with the processor at the computer-implemented loan origination system, a plurality of attachments, a first subset of the plurality of attachments corresponding to, and accessible by, the sales object, a second subset of the plurality of attachments corresponding to, and accessible by, the operations object.

5. The computer program product of claim 4, wherein the computer is further caused to automatically migrate, upon generation of the second first level object, the first subset of the plurality of attachments to the second subset of the plurality of attachments.

6. The computer program product of claim 1, wherein each of the plurality of first level objects corresponds to a sequential stage of a loan origination pipeline, the sales object corresponding to a sales stage, the operations stage corresponding to an operations stage, the sales stage occurring prior to the operations stage.

7. The computer program product of claim 6, wherein the computer is further caused to generate the update for a retracement within the loan origination pipeline to a previous stage.

8. The computer program product of claim 1, wherein the computer is further caused to prevent access to the second subset of the plurality of second level objects until the generation of the second first level object and until generation of the object linkage.

9. The computer program product of claim 1, wherein the multi-object data structure is a table with a linkage grouping corresponding to a plurality of columns in a same row.

10. The computer program product of claim 1, wherein the multi-object data structure is a table with a linkage grouping corresponding to a plurality of rows in a same column.

11. The computer program product of claim 1, wherein the multi-object data structure is a tree-based data structure having a first level plurality of nodes corresponding to the plurality of first level objects and a second level plurality of nodes corresponding to the plurality of second level objects, wherein a connection indicium indicates the object linkage between each of the first level plurality of nodes.

12. A computer-implemented loan origination system comprising:
a processor that generates a plurality of first level objects, generates a plurality of second level objects, generates an object linkage between the plurality of first level objects, and automatically propagates an update of one of a second subset of the plurality of second level objects to a first subset of the plurality of second level objects, the plurality of first level objects comprising a sales object and an operations object, the first subset of the plurality of second level objects corresponding to, and accessible by, the sales object, the second subset of the plurality of second level objects corresponding to, and accessible by, the operations object, the object linkage providing each of the plurality of first level objects shared access to each of the plurality of second level objects; and
a memory device that stores a multi-object data structure to store the object linkage.

13. The computer-implemented loan origination system of claim 12, wherein the processor automatically generates the second first level object upon one or more criteria corresponding to the first subset of the plurality of second level objects being met.

14. The computer-implemented loan origination system of claim 13, wherein the processor automatically determines, upon generation of the second first level object, data from the first subset of the plurality of second level objects that are applicable to the second subset of the plurality of second level objects, the computer further being caused to automatically migrate the data from the first subset of the plurality of second level objects to the second subset of the plurality of second level objects.

15. The computer-implemented loan origination system of claim 12, wherein the processor automatically generates a plurality of attachments, a first subset of the plurality of attachments corresponding to, and accessible by, the sales object, a second subset of the plurality of attachments corresponding to, and accessible by, the operations object.

16. The computer-implemented loan origination system of claim 15, wherein the processor automatically migrates, upon generation of the second first level object, the first subset of the plurality of attachments to the second subset of the plurality of attachments.

17. The computer-implemented loan origination system of claim 12, wherein each of the plurality of first level objects corresponds to a sequential stage of a loan origination pipeline, the sales object corresponding to a sales stage, the operations stage corresponding to an operations stage, the sales stage occurring prior to the operations stage.

18. The computer-implemented loan origination system of claim 17, wherein the processor generates the update for a retracement within the loan origination pipeline to a previous stage.

19. The computer-implemented loan origination system of claim 12, wherein the processor prevents access to the second subset of the plurality of second level objects until the generation of the second first level object and until generation of the object linkage.

20. The computer-implemented loan origination system of claim 12, wherein the multi-object data structure is a tree-based data structure having a first level plurality of nodes corresponding to the plurality of first level objects and a second level plurality of nodes corresponding to the plurality of second level objects, wherein a connection indicium indicates the object linkage between each of the first level plurality of nodes.
